(19) United States
(12) Patent Application Publication
(10) Pub. No.: US 2025/0305886 A1
(43) Pub. Date: Oct. 2, 2025

(54) PYROMETER ELECTRONICS DESIGN FOR MODERN INDUSTRY PROTOCOLS

(71) Applicant: BASF CORPORATION, Florham Park, NJ (US)

(72) Inventors: Patrick J. NYSTROM, Portland, OR (US); Ronald A. PALFENIER, Portland, OR (US)

(21) Appl. No.: 18/866,370

(22) PCT Filed: May 24, 2023
(86) PCT No.: PCT/US2023/023299

§ 371 Date: Nov. 15, 2024

Related U.S. Application Data
(60) Provisional application No. 63/346,357, filed on May 27, 2022.

(51) Int. Cl. G01J 5/24; G01J 5/06

(52) U.S. Cl. CPC G01J 5/24; G01J 5/064

(57) ABSTRACT

A radiometric temperature measurement system comprising a photo detector, a one or more processing components on a first board, and one or more input/output (I/O) components on a second board. The one or more processing components may include one or more digitization circuits operatively coupled to the photo detector, one or more level shifters, a microcontroller operatively coupled to the one or more digitization circuits through the one or more level shifters, and a first part of an input/output (I/O) connector. The microcontroller may include one or more of: an analog to digital converter (ADC), a processor, an EVENT system (EVSYS), a capture control unit (CCU), a general-purpose input/output (GPIO), and a universal asynchronous receiver-transmitter (UART) interface. The one or more VO components may include one or more of a communications interface, protection circuitry, and a second part of the VO connector.

### TECHNICAL FIELD

This invention relates to radiometric temperature measurement systems (also known as “pyrometers”) and more particularly to pyrometer circuitry design having improved low temperature measurement accuracy and flexibility of application.

### BACKGROUND

A pyrometer is a type of remote-sensing thermometer for non-contact measurement of a temperature of fixed or moving objects. Pyrometer systems employ a relationship between an intensity of emitted radiation and a source temperature as defined by the Planck equation, which shows that the radiation emitted by any object is a function of its temperature, emissivity, and the measurement wavelength.

Pyrometer systems may be used for measuring the temperature of surfaces such as the surface of semiconductor silicon wafers housed within a process chamber while integrated circuits (“ICs”) are formed on the wafer. Virtually every process step in silicon wafer fabrication depends on wafer temperature measurement and control. As wafer sizes increase and the critical dimension of very large scale ICs scales deeper into the sub-micron range, the requirements for wafer-to-wafer temperature repeatability during processing become ever more demanding. Inadequate wafer temperature control during processing may reduce fabrication yield and directly translates to lost revenues.

Processes such as physical vapor deposition (“PVD”), high-density plasma chemical vapor deposition (“HDP-CVD”), epitaxy, and rapid thermal processing (“RTP”) can be improved if the wafer temperature is accurately measured and controlled during processing. In RTP there is a special importance to temperature monitoring because of the high temperatures and the importance of tightly controlling the thermal budget, as is also the case for Chemical Mechanical Polishing (“CMP”) and Etch processes. Accordingly, there is a desire for accurate temperature measurement systems in these and other measurement environments.

### SUMMARY

A radiometric temperature measurement system may include a photo detector, one or more processing components on a first board, and one or more input/output (I/O) components on a second board. The one or more processing components may include one or more digitization circuits operatively coupled to the photo detector, one or more level shifters, a microcontroller operatively coupled to the one or more digitization circuits through the one or more level shifters, and a first part of an input/output (I/O) connector. The microcontroller may include one or more of: an analog to digital converter (ADC), a processor, an EVENT system (EVSYS), a capture control unit (CCU), a general-purpose input/output (GPIO), and a universal asynchronous receiver-transmitter (UART) interface. The one or more I/O components may include one or more of a communications interface, protection circuitry, and a second part of the I/O connector. The first part of the I/O connector and the second part of the I/O connector are configured to be attached and detached.

### BRIEF DESCRIPTION OF DRAWINGS

Other objects and advantages of the present disclosure will become apparent to those skilled in the art upon reading the following description of embodiments and appended claims, in conjunction with the accompanying drawings, in which like reference numerals have been used to designate like elements, and in which:

FIG. 1 is a block diagram of electronic circuitry for a novel pyrometer, according to one or more embodiments;

FIG. 2 is a perspective view of the electronic circuitry within a housing, according to one or more embodiments;

FIG. 3 is a top view of a one or more processing components of the electronic circuitry, according to one or more embodiments;

FIG. 4 is a bottom view of the one or more processing components of the electronic circuitry, according to one or more embodiments;

FIG. 5 is a top view of an input/output (I/O) board of the electronic circuitry, according to one or more embodiments; and

FIG. 6 is a bottom view of the one or more I/O components of the electronic circuitry, according to one or more embodiments.

The figures are for purposes of illustrating example embodiments, but it is understood that the inventions are not limited to the arrangements and instrumentality shown in the drawings. In the figures, identical reference numbers identify at least generally similar elements.

### DETAILED DESCRIPTION

According to one or more embodiments described herein, systems, methods, apparatuses, and non-transitory computer executable media related to a circuitry design for a radiometric temperature measurement system (i.e., a “pyrometer”) are provided. Optical pyrometers and fiber optic thermometers employing the Planck Equation are used for in-situ measurement in numerous industrial settings (e.g., semiconductor wafer processing, industrial glass production, and petrochemical processes, to name a few.).

Recent advances in semiconductor technology have enabled better instrumentation design over conventional pyrometers. For example, in conventional pyrometers, power dissipation may occur from processing components and voltage may leak into analog sensing circuitry, which causes excess drift and error. Voltage buffers for analog reference in conventional pyrometers provide insufficient drive and recovery speed, which results in reading spread and limited photodiode selection. Conventional pyrometers typically require a low-voltage power input, which requires short cables and expensive interface boxes for use in standard industrial settings that use standard industry protocols with higher operating voltages (e.g., Industry 4.0 and/or Industry 5.0). Further, protection circuitry on inputs of conventional pyrometers is not robust enough for these industrial settings. New functionality for industry protocols is also difficult to implement on conventional pyrometers due to memory and speed limitations of processing circuitry and output is typically limited to a single electrical interface (RS-485 serial). Thermal coupling between components and the cradle of conventional pyrometers tend to be suboptimal due to the required thickness of printed circuit board (PCB) within the pyrometer.

In one or more embodiment described herein, power dissipation may be reduced by more than 50% as compared to conventional pyrometers. Updated power input circuitry may allow for compliance with industry standard 24 VDC for Industry 4.0 and/or Industry 5.0. Robust input protection circuitry may be able to handle surge energies required for Industry 4.0 and/or Industry 5.0. Memory capacity and processing bandwidth may also be greatly increased, which may also allow greater compliance with Industry 4.0 and/or Industry 5.0. Analog reference drive and recovery speed may be greatly increased. PCB thickness may be reduced by 50% or more to improve thermal flow. The pyrometry circuitry may include a processing board, with one or more operably coupled processing components disposed thereon, for measurement and processing; and one or more separate I/O interface boards to facilitate adaptation to new protocols for Industry 4.0 and/or Industry 5.0. Embodiments may allow for direct measurements of integration capacitor values in-situ. Further, all components may be 0402 size or larger which may improve circuit board yield.

One or more embodiments will now be described more fully hereinafter with reference to the accompanying drawings, which form a part hereof, and which show, by way of non-limiting illustration, certain examples. Subject matter may, however, be described in a variety of different forms and, therefore, covered or claimed subject matter is intended to be construed as not being limited to any examples set forth herein. Among other things, subject matter may be described as methods, devices, components, or systems. Accordingly, examples may take the form of hardware, software, firmware, or any combination thereof (other than software per se). The following detailed description is, therefore, not intended to be taken in a limiting sense.

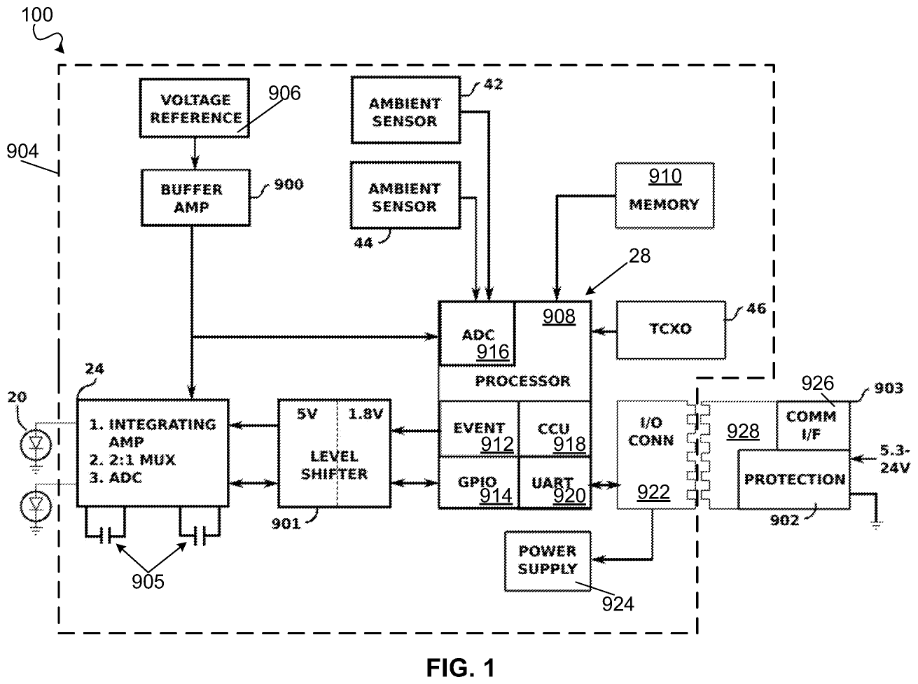

Referring now to FIG. 1, a block diagram of electronic circuitry 100 for a novel pyrometer is shown, according to one or more embodiments. As described, the electronic circuitry 100 may utilize components, which may be arranged in a highly compact format such that an overall size of the novel pyrometer may be reduced from conventional pyrometers. This form factor may enable direct coupling of a photo detector 20 and the electronic circuitry 100 to collection optics (not shown) and, therefore, may eliminate a fiber cable often found in prior optical thermometers. Eliminating the fiber cable in semiconductor temperature measurement applications may reduce optical losses and signal variations.

In one or more embodiments, the electronic circuitry 100 may include a photo detector 20, one or more processing components 904, and one or more input/output (I/O) components 903. The one or more processing components 904 may be disposed on a first electronics board or substrate and the one or more input/output (I/O) components 903 may be disposed on a second electronics board or substrate. The one or more processing components 904 may be disposed on one or more first electronics boards or substrates. The one or more I/O components 903 may be disposed on one or more second electronics boards or substrates. The one or more processing components 904 may include one or more digitization circuits 24 operatively coupled to the photo detector 20, one or more level shifters 901, a microcontroller 28 operatively coupled to the one or more digitization circuits 24 through the one or more level shifters 901, a reference voltage source 906, a buffer amplifier 900, a first ambient sensor 42 and a second ambient sensor 44, a memory 910, a system clock 46, a power supply 924, and a first part of an I/O connector 922. The microcontroller 28 may include one or more of: an analog to digital converter (ADC) 916, a processor 908, an EVENT system (EVSYS) 912, a capture control unit (CCU) 918, a general-purpose input/output (GPIO) 914, and a universal asynchronous receiver-transmitter (UART) interface 920. The one or more I/O components 903 may be operatively coupled to the one or more processing components 904 through the I/O connector 922. The one or more I/O components 903 may be separate from the one or more processing components 904 and may include one or more of a communications interface 926, a second part of the I/O connector 928, and a protection circuitry 902.

The collection optics may direct radiation to an optional wavelength selective filter (not shown) and/or the photo detector 20. The collection optics may alternatively include rigid or flexible fiber optic light pipes and/or a lens system for measuring the temperature of predetermined areas on an object. The target medium may include gases, plasmas, heat sources, and other non-solid target media. The optional wavelength selective filter may select which wavelengths of radiation are measured. In an example, the optional wavelength selective filter may include a hot/cold mirror surface for reflecting unneeded wavelengths of radiation back toward the object. The optional wavelength selective filter may be housed to maintain them in a clean and dry condition.

The photo detector 20 may convert radiation into an electrical signal. In an example, the photo detector 20 may be a high efficiency solid-state detector device formed from silicon, InGaAs, InAsSb, or a specially doped AlGaAs material having a narrow bandpass detection characteristic centered around 900 nm. InGaAs detectors may be sensitive to radiation wavelengths as long as 2,700 nm. InAsSb detectors may be sensitive to wavelengths as long as 11,000 nm, Silicon detectors may be nominally insensitive to wavelengths longer than 1,200 nm, however the photosensitivity of silicon diminishes with longer wavelengths. AlGaAs material may have a photo sensitivity peak at 900 nm and may diminish by about three orders of magnitude at 1,000 nm. Alternatively, detector materials such as GaP, GaAsP, GaAs, and InP may be suitable for use as wavelength-selective detectors at wavelengths less than 1,000 nm.

The photo detector 20 materials for wafer temperature measurements may be chosen for photo sensitivity around the optimum wavelengths for measuring silicon, GaAs, and InP wafers. In particular, the material may be chosen for sensitivity at wavelengths shorter than the 1,000 nm (i.e., the bandgap for silicon wafers), yet as long as possible to provide a maximum amount of Planck Blackbody Emission without significant sensitivity to radiation transmitted through the wafer.

In an example, the photo detector 20 may be made from AlGaAs, a tertiary compound, and may be doped to optimize its photo sensitivity around 900 nm. This detector material is insensitive to radiation wavelengths transmitted through a silicon wafer, and to much visible ambient light. This detector material may also have a narrow wavelength detection sensitivity, minimizing the need for an optional wavelength selective filter (not shown). One or more suitable photo detectors may include detectors manufactured by Opto Diode Corporation, located in Newbury Park, Calif.

In situations where a sharper cutoff is desired, the photo detector 20 may be combined with the optional wavelength selective filter to achieve a wavelength selectivity compounding affect. In these situations, it may be easier to design and manufacture band pass filters that are matched for use with the particular detector material.

The ability to eliminate the optional wavelength selective filter and/or through the use of a simple band-pass filter may allow the photo detector 20 to be spaced much closer (about 0.25 mm verses 2.54 mm) to the collection optics, which may enable the collection of up to about ten times more radiation. The close spacing may also provide better low temperature measurement performance (e.g., the ability to measure 200° C. compared to 350° C. with a traditional band-pass filter and a traditional silicon broad band detector).

As shown in FIG. 1, the photo detector 20 may be a low current output device and may include one or more photodiodes. The one or more photodiodes may produce an analog current proportional to the IR intensity of an object being measured. The photo detector 20 may be coupled to the one or more processing components 904. The photo detector 20 may be connected directly to one or more inputs of the one or more digitization circuits 24. The one or more inputs of the one or more digitization circuits 24 may be coupled to the one or more processing components 904. The one or more digitization circuits 24 may include one or more of an integrating amplifier, a 2:1 multiplexor, and/or an analog to digital converter (ADC).

In an example, the one or more digitization circuits 24 may each be a dual input, wide dynamic range, charge-digitizing ADC with 20-bit resolution. The one or more digitization circuits 24 may use two integrators, which may allow for continuous charge integration. Each input may use two integrators; while one is being digitized, the other may be integrating.

For each of its one or more inputs, the one or more digitization circuits 24 may combine current-to-voltage conversion, continuous integration, programmable full-scale range, A/D conversion, and digital filtering to achieve a precision, wide dynamic range digital result. In addition to the internal programmable full-scale ranges, one or more external integrating capacitors 905 may allow for an additional user-settable full-scale range of up to 8000 pC. The one or more external integrating capacitors 905 may be 0402 size, which may allow for very close connection to pins of the ADC.

The one or more digitization circuits 24 may perform current-to-voltage integration on the two input channels and then perform a multiplexed A/D conversion. Each input may have two integrators so that the current-to-voltage integration may be continuous in time. The output of the four integrators may be switched to one delta-sigma (ΔΣ) converter via a four input multiplexer. With the one or more digitization circuits 24 in the continuous integration mode, the output of the integrators from one side of both of the inputs may be digitized while the other two integrators are in the integration mode.

This integration and A/D conversion process may be controlled by a timing signal that originates from the system clock 46. In an example, the system clock 46 may be a temperature compensated crystal oscillator (TCXO), which may be a crystal oscillator with a temperature-sensitive reactance circuit in its oscillation loop to compensate for frequency-temperature characteristics inherent to the crystal unit. The one or more digitization circuits 24 may operate at a clock rate of about 15 MHz or more. With a 15 MHz system clock 46, the integrator combined with the ΔΣ converter may accomplish a single 20-bit conversion in approximately 135 μs. The results from each side of each signal input may be stored in a serial output shift register.

To provide single-supply operation, the internal ADC may utilize a differential input, with the positive input tied to VREF from the reference voltage source 906. In an example, V_{REF} may be approximately 4.096V. When an integration capacitor is reset at the beginning of each integration cycle, the capacitor may charge to VREF. This charge may be removed in proportion to the input current. At the end of the integration cycle, the remaining voltage may be compared to V_{REF}.

The external V_{REF} may be used to reset the integration capacitors before an integration cycle begins. It may also be used by the ΔΣ converter while the converter is measuring the voltage stored on the integrators after an integration cycle ends. During this sampling, the external V_{REF} may supply charge needed by the ΔΣ converter. For an integration time of 500 μs, this charge may translate to an average V_{REF} current of approximately 150 μA. The amount of charge needed by the ΔΣ converter may be independent of the integration time; therefore, increasing the integration time may lower the average current. For example, an integration time of 1000 μs may lower the average V_{REF} current to 75 μA. V_{REF} may need to be stable during the different modes of operation.

The ΔΣ converter may measures the voltage on the integrator with respect to V_{REF}. Since the integrator capacitors are initially reset to V_{REF}, any droop in V_{REF} from the time the capacitors are reset to the time when the converter measures the integrator's output may introduce an offset. It may also be important that V_{REF} be stable over longer periods of time as changes in V_{REF} correspond directly to changes in the full-scale range. Finally, V_{REF} should introduce as little additional noise as possible. For reasons mentioned above, the V_{REF} may be buffered with the buffer amplifier 900. This buffer amplifier 900 may have a unity-gain bandwidth greater than 4 MHz, low noise, and input/output common-mode ranges that support V_{REF}. The buffer amplifier 900 may have a slew rate of 90V/μs and 50 mA drive.

The one or more digitization circuits 24 may be a 5V device and may accommodate logic levels which range from 0V to 5V. Several of the signals to the one or more digitization circuits 24 may be constantly-changing digital signals, For example, the signal from the system clock 46 may be a 10-15 MHz signal and a convert signal, described in detail below, may operate at several KHz. Every time one of these signals changes from one digital state to the other, the conductor carrying the signal may have to charge its self-capacitance as well as the parasitic capacitances in the connected components. This rapidly changing current at each edge of the digital signal may cause excessive power consumption and may radiate noise into the surrounding circuitry.

As shown in FIG. 1, the remainder of the components may operate on a lower voltage (e.g., 1.8V). The one or more level shifters 901 may be used to convert the low level 1.8V signals into 5V signals “just in time” (i.e., physically very close to the one or more digitization circuits 24, which minimizes the portion of the electronic circuitry 100 where the higher-level signals must flow. Besides lowering the total power consumption, keeping these signals short may minimize their radiation and keeps the analog portion of the circuit quieter, which may results in better analog readings.

The one or more level shifters 901 may also convert the digital signal output from the one or more digitization circuits 24 to the low level 1.8V for processing by the microcontroller 28. The microcontroller 28, the one or more digitization circuits 24, and the one or more level shifters 901 may all be part of the one or more processing components 904. The one or more processing components 904 may be disposed on a printed circuit board (PCB). The microcontroller 28 may control operation of the one or more digitization circuits 24 through a convert (CONV) signal and may in turn convert the shifted digital signal into a temperature reading.

The complex CONV signal may be generated by the processor 908 using the CCU 918 and may be based off the timing signal from the system clock 46 and may use a novel algorithm that extends the natural period of the integration from a few microseconds to as long as desired (e.g., 1 second). The algorithm may be stored in the form of computer executable code in the memory 910. The processor 908 may be operatively coupled to the memory 910. The algorithm may allow for the integration period to be arbitrarily long to capture low-level signals, yet still controllable in 200 ns increments.

The CONV signal output from the processor 908 may be routed to better locations with respect to the microcontroller 28 layout using the EVSYS 912 of the processor 908. The EVSYS 912 may be a peripheral that allows other on-chip peripherals to signal directly to each other independently of a central processing unit (CPU) (e.g., the processor 908). Through the EVSYS 912, an output of one peripheral may be propagated to many other peripherals. This may improve response time and reduce power consumption while enabling more complex system configurations.

The EVSYS 912 may be split into multiple channels. Each channel may have a single event generator and multiple event users. Since some peripherals may operate asynchronously while others are synchronized to a peripheral clock, the EVSYS 912 may contain two subchannels for each type of peripheral. To make both types of peripherals compatible, the EVSYS 912 may synchronize asynchronous events for the synchronous peripherals.

The EVSYS 912 may allow for electrically superior connections (e.g., better signal integrity and lower emissions) compared to using the timer/counter pins of processors used in conventional pyrometer circuitry. The EVSYS 912 may allow for autonomous, low-latency, and configurable communication between peripherals. Several peripherals can be configured to generate and/or respond to signals known as events. The exact condition to generate an event, or the action taken upon receiving an event, may be specific to each peripheral. Communication may be made without CPU intervention and without consuming system resources such as bus or RAM bandwidth. This may reduce the load on the CPU and other system resources as compared to a traditional interrupt-based system.

Utilizing the EVSYS 912, chip pin-out may be changed to optimize routing, improve signal quality, and reduce the number of layers required to connect the one or more processing components 904 with one another. For example, the EVSYS 912 may reduce or eliminate the need for many vias and interconnected found on conventional PCBs used in pyrometers. This may reduce the overall thickness of the one or more processing components 904 to approximately 0.8 mm as compared to 1.6 mm in conventional pyrometers. This may have multiple benefits. The one or more processing components 904 may be electrically quieter since the inter-layer capacitance is higher and the components may be better coupled thermally, which may make ambient corrections from the first ambient sensor 42 and the second ambient sensor 44 more effective and accurate.

Conventional pyrometers teach away from reducing the thickness of PCBs. Thinner PCBs may be more flexible, which is a drawback as any mechanical stress on analog components (e.g., ADC, reference, or buffer) will cause signal errors due to piezoelectric and other effects in the die. However, due to the small size of the novel pyrometer and the fact that may be mounted and calibrated within a rigid metal housing, a much thinner PCB may be used. This may allow for better measurements pf the ambient temperature of the analog components (since the thermal resistance between the sensor and the sensed component is reduced), and for any self-heating of the components to more easily flow to the housing. These effects both allow for more accurate temperature compensation, and thus make more accurate measurements.

Temperature compensation may be determined from information gained from the first ambient sensor 42 and the second ambient sensor 44, which account for deviations in component performance having differing temperature-dependent physical behaviors. For example, the gain of the one or more digitization circuits 24 may change with temperature along with characteristics of the photo detector 20, system clock 46, reference voltage source 906, and other components. It may also beneficial to use an internal temperature sensor to monitor and compensate for the temperature of objects within the pyrometer system that occupy any part of the field of view (“FOV”) of the photo detector 20. The first ambient sensor 42 and the second ambient sensor 44 may each generate an analog signal that represents an accuracy of +/−1° C., and therefore may not require calibration.

The analog signals may be converted to digital signals by the ADC 916 for processing by the processor 908. For example, the analog signals may be inputs to the photodetector 20 current to temperature algorithm as the response of the photodetector 20 may be affected by ambient temperature. The reference voltage source 906, buffer amplifier 900, and one or more digitization circuits 24 may all have ambient dependencies as well. The analog signals representing the ambient temperature may allow these effects to be canceled.

The microcontroller 28 may include the CCU 918. The CCU 918 may be used to accurately produce the CONV timing. The microcontroller 28 may communicate with the one or more digitization circuits 24 (via the one or more level shifters 901) though the EVSYS 912 and the GPIO 914. The EVSYS may be used to route the CONV line. The GPIO 914 may generate digital controls for the one or more digitization circuits 24 (except for the CONV line), including, but not limited to, a range select, test mode, and Serial Peripheral Interface (SPI) select/clock.

The microcontroller 28 may include the UART interface 920 coupled to the first part of the I/O connector 922. The first part of the I/O connector 922 may carry signals from the second part of the I/O connector 928 of the separate one or more I/O components 903 to the microcontroller 28. The first part of the I/O connector 922 may also be connected to the power supply 924. The power supply 924 may step down an input voltage of 24 VDC to the operating voltages described above. This may allow for much longer cables between the novel pyrometer and its host. It should be noted that conventional industrial devices that measures signals as small as those measured by the novel pyrometer described herein are not usually powered by 24 volts because stepping high input voltages down to the low voltages required (e.g., 5V and 1.8V) may generate noise that interferes with readings. In an example, the power supply 924 may include protection circuitry of its own.

The first part of the I/O connector 922 may be attached/detached to the second part of the I/O connector 928 located with the one or more I/O components 903. As described above, the allows for the electronic circuitry 100 to be split into two boards, the one or more processing components 904 on the processing board and the one or more I/O components 903 on an I/O board. The high-precision analog front end and processing may be performed via the one or more processing components 904. The host interface and protection circuitry may part of the one or more I/O components 903. This may allow new versions of the novel pyrometer to be designed quickly to satisfy new application requirements, while keeping the calibrated and certified circuitry the same. In other words, the circuitry requiring calibration can now be used in a variety of applications depending on the interface required.

The one or more I/O components 903 may include the communications interface 926. The communications interface 926 may allow for communications through one or more interfaces and/or protocols, including, but not limited to, Ethernet, EtherCAT, CAN, ProfiBus, ProfiNet, and USB.

The one or more I/O components 903 may include the grounded protection circuitry 902 that may provide a protection level that is unusually robust for an instrument in this small of an envelope. In an example, the grounded protection circuitry may include one or more fuses configured in series and a transient-voltage-suppression (TVS) diode which clamps the input voltage to safe levels for the power supply 924 and may also protect against polarity faults. If greater protection is required and space is permitted, grounded protection circuitry 902 may also include other devices, such as gas discharge tubes, to comply with higher fault specs.

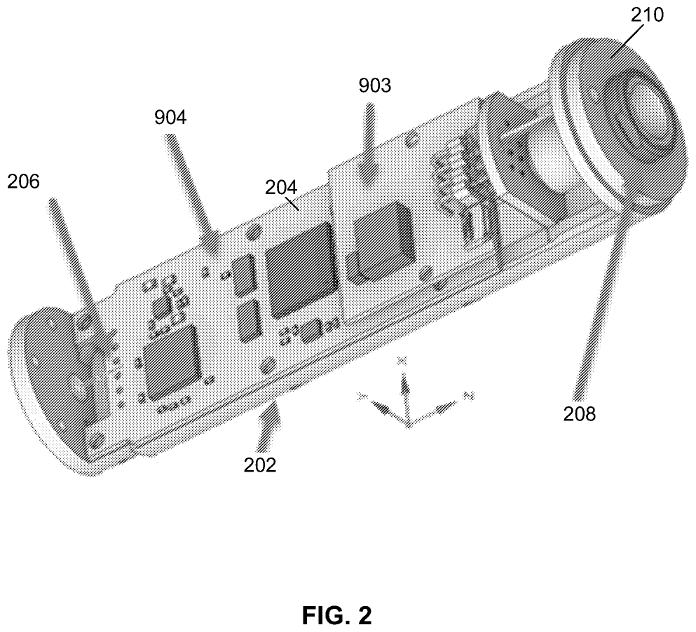

Referring now to FIG. 2, a perspective view of the electronic circuitry 100 within a housing 202 is shown. The housing 202 may be thermally conductive. Although the housing 202 shown in FIG. 2 is substantially cylindrical in shape, it may be of any shape and size. For example, the housing 202 may be rectangular in shape and/or may be part of a portable handheld device. The housing 202 may contain the one or more processing components 904 and the one or more I/O components 903. The one or more I/O components 903 may be disposed above an upper surface 204 of the processing board on which the one or more processing components 904 are located. The one or more processing components 904 may include a photo detector input connection 206 that is coupled to the photo detector 20. A connector 208 may be integrated into an end piece 210 of the housing 202. The connector 208 may be coupled to the one or more I/O components 903 and may provide power input and communications.

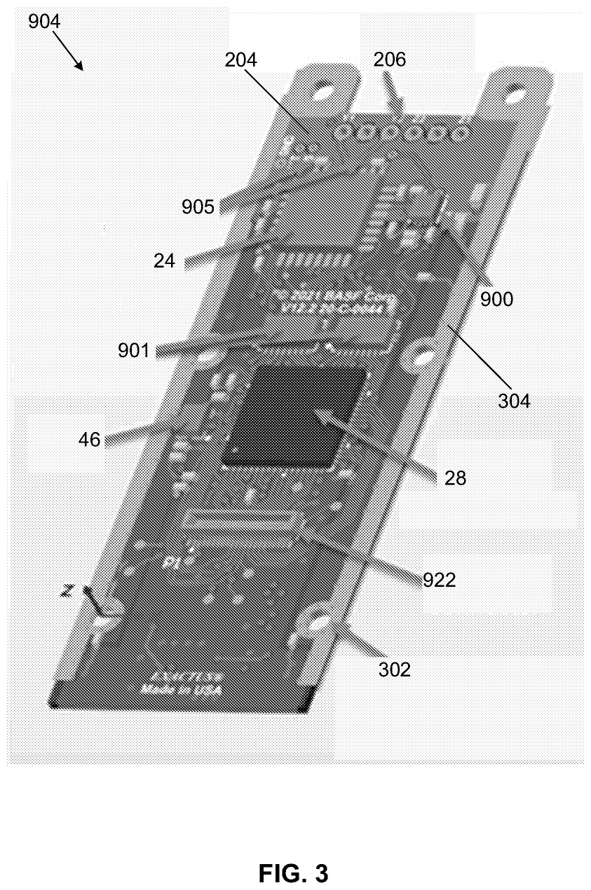

Referring now to FIG. 3, a top view of the one or more processing components 904 illustrating the upper surface 204 is shown. The one or more processing components 904 may include one or more mounting holes 302 in thermal conduction rails 304. In an example, the thermal conduction rails 304 may be on the perimeter of the one or more processing components 904. In an example, the upper surface 204 may include the photo detector input connection 206, the one or more external integrating capacitors 905, the one or more digitization circuits 24, the one or more level shifters 901, the buffer amplifier 900, the system clock 46, the microcontroller 28, and the first part of the I/O connector 922.

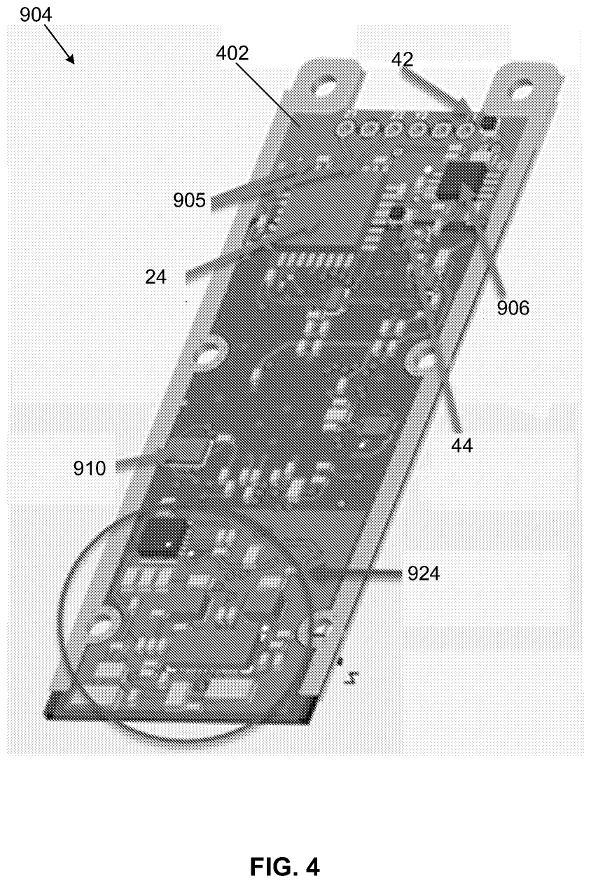

Referring now to FIG. 4, a bottom view of the one or more processing components 904 illustrating a lower surface 402 of the processing board is shown. In an example, the lower surface 402 may include the one or more external integrating capacitors 905, the one or more digitization circuits 24, the memory 910, the first ambient sensor 42 and the second ambient sensor 44, the reference voltage source 906, and the power supply 924 circuit.

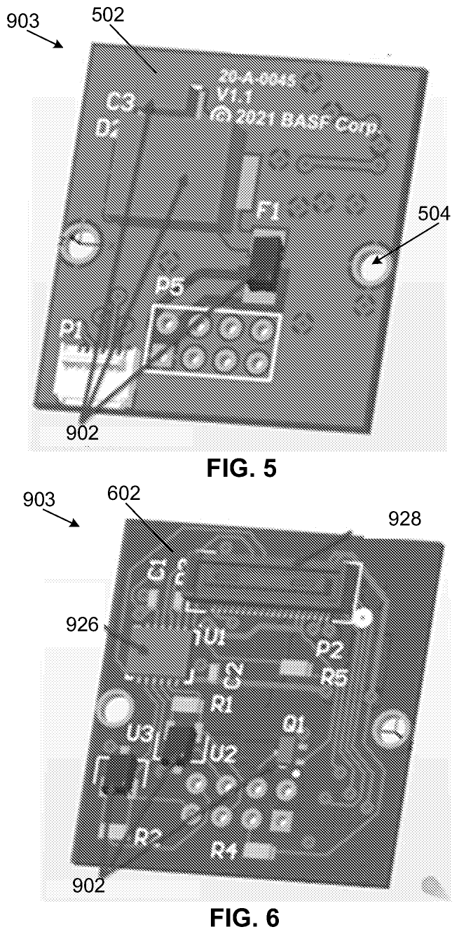

Referring now to FIG. 5, a top view of the one or more I/O components 903 illustrating an upper surface 502 of the I/O board is shown. The one or more I/O components 903 may include one or more mounting holes 504. The upper surface 502 may include the protection circuitry 902.

Referring now to FIG. 6, a bottom view of the one or more I/O components 903 illustrating a lower surface 602 of the I/O board is shown. The lower surface 602 may include the protection circuitry 902, the communications interface 926, and the second part of the I/O connector 928.

Additional examples of the presently described method and device embodiments are suggested according to the structures and techniques described herein. Other non-limiting examples may be configured to operate separately or may be combined in any permutation or combination with any one or more of the other examples provided above or throughout the present disclosure.

It will be appreciated by those skilled in the art that the present disclosure may be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The terms “including” and “comprising” should be interpreted as meaning “including, but not limited to.” If not already set forth explicitly in the claims, the term “a” should be interpreted as “at least one” and the terms “the, said, etc.” should be interpreted as “the at least one, said at least one, etc.”

The present disclosure is described with reference to block diagrams and operational illustrations of methods and devices. It is understood that each block of the block diagrams or operational illustrations, and combinations of blocks in the block diagrams or operational illustrations, may be implemented by means of analog or digital hardware and computer program instructions. These computer program instructions may be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks may occur out of the order noted in the operational illustrations. For example, two blocks shown in succession may be executed substantially concurrently or the blocks may sometimes be executed in the reverse order, depending upon the functionality/acts involved.

For the purposes of this disclosure a non-transitory computer readable medium (or computer-readable storage medium/media) stores computer data, which data may include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which may be used to tangibly store the desired information or data or instructions and which may be accessed by a computer or processor.

For the purposes of this disclosure the term “server” should be understood to refer to a service point which provides processing, database, and communication facilities. By way of example, and not limitation, the term “server” may refer to a single, physical processor with associated communications and data storage and database facilities, or it may refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2^{nd}, 3^{rd}, 4^{th}, or 5^{th} generation (2G, 3G, 4G or 5G) cellular technology, Bluetooth, 802.11b/g/n, or the like. Network access technologies may enable wide area coverage for devices, such as client devices with varying degrees of mobility, for example. In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

The present disclosure further relates to any one or more of the following paragraphs.

A radiometric temperature measurement system that may include: a photo detector; one or more processing components that may include one or more digitization circuits operatively coupled to the photo detector, one or more level shifters, and a microcontroller operatively coupled to the one or more digitization circuits through the one or more level shifters, and a first part of an input/output (I/O) connector. The microcontroller may include one or more of: an analog to digital converter (ADC), a processor, an EVENT system (EVSYS), a capture control unit (CCU), a general-purpose input/output (GPIO), and a universal asynchronous receiver-transmitter (UART) interface; and one or more input/output (I/O) components operatively coupled to the one or more processing components. The one or more input/output (I/O) components may include one or more of a communications interface, protection circuitry, and a second part of the input/output (I/O) connector.

The one or more processing components may further include: a reference voltage source operatively coupled to the digitization circuit through a buffer amplifier.

The reference voltage may be approximately 4.096 V.

The reference voltage source may be operatively coupled to the analog to digital converter through the buffer amplifier.

The one or more processing components may be disposed on a first board and the one or more input/output components may be disposed on a second board.

The one or more digitization circuits may include one or more of: an integrating amplifier; a 2:1 multiplexor; an analog to digital converter; and one or more external integrating capacitors.

The one or more level shifters may convert one or more signals received from the one or more processing components at about 1.8 V to one or more signals sent to the digitization circuit at about 5 V and may converts one or more signals received from the digitization circuit at about 5 V to one or more signals sent to the one or more processing components at about 1.8 V.

The one or more signals received from the one or more processing components may include a convert (CONV) signal from the EVENT system.

The one or more signals received from the one or more processing components may include digital controls for the digitization circuit.

The one or more processing components may further include: one or more ambient temperature sensors operatively coupled to the analog to digital converter.

The one or more processing components may further include: a system clock and a memory operatively coupled to the processor, the memory storing computer-readable instructions that, when executed by the processor, can generate a convert signal based off a timing signal from the system clock.

The CONV signal can extend a natural period of the integration of digitization circuit from a few milliseconds to as long as desired.

The system clock and the digitization circuit can operate at a clock rate of about 15 MHz.

The one or more processing components may further include: a power supply operatively coupled to the first part of the I/O connector, the power supply configured to step down an input voltage of about 24 VDC to an operating voltage of the one or more processing components.

The first part of the I/O connector and the second part of the I/O connector may be configured to be attached and detached.

The communications interface may be configured for communications through one or more interfaces and/or protocols, which can include, Ethernet, EtherCAT, CAN, ProfiBus, ProfiNet, and/or USB.

The protection circuitry may include one or more fuses configured in series and a transient-voltage-suppression (TVS) diode.

One or more of the one or more processing components and the one or more I/O components may be located on a printed circuit board (PCB) having a thickness of approximately 0.8 mm.

The one or more digitization circuits may convert an analog signal from the photo detector proportional to an intensity of infrared (IR) radiation to a 20-bit digital number.

The EVSYS may include a peripheral that allows other peripherals on the one or more processing components to signal directly to each other independently of the processor.

Certain embodiments and features have been described using a set of numerical upper limits and a set of numerical lower limits. It should be appreciated that ranges including the combination of any two values (e.g., the combination of any lower value with any upper value, the combination of any two lower values, and/or the combination of any two upper values) are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

Although only a few examples have been described in detail above, those skilled in the art will readily appreciate that many modifications can be possible in the examples without materially departing from this subject disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw cannot be structural equivalents in that a nail employs a cylindrical surface to secure wooden parts together, whereas a screw employs a helical surface, in the environment of fastening wooden parts, a nail and a screw can be equivalent structures. It is the Applicant's express intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A radiometric temperature measurement system comprising:
a photo detector;
one or more processing components comprising one or more digitization circuits operatively coupled to the photo detector, one or more level shifters, and a microcontroller operatively coupled to the one or more digitization circuits through the one or more level shifters, and a first part of an input/output (I/O) connector, the microcontroller comprising one or more of: an analog to digital converter (ADC), a processor, an EVENT system (EVSYS), a capture control unit (CCU), a general-purpose input/output (GPIO), and a universal asynchronous receiver-transmitter (UART) interface; and
one or more I/O components operatively coupled to the one or more processing components, the one or more I/O components comprising one or more of a communications interface, protection circuitry, and a second part of the I/O connector.

2. The system of claim 1, wherein the one or more processing components further comprise:
a reference voltage source operatively coupled to the digitization circuit through a buffer amplifier.

3. The system of claim 2, wherein the reference voltage is approximately 4.096 V.

4. The system of claim 2, wherein the reference voltage source is operatively coupled to the ADC through the buffer amplifier.

5. The system of claim 1, wherein the one or more processing components are disposed on a first board and the one or more I/O components are disposed on a second board.

6. The system of claim 1, wherein the one or more digitization circuits comprise one or more of:
an integrating amplifier;
a 2:1 multiplexor;
an ADC; and
one or more external integrating capacitors.

7. The system of claim 1, wherein the one or more level shifters convert one or more signals received from the one or more processing components at about 1.8 V to one or more signals sent to the digitization circuit at about 5 V and converts one or more signals received from the digitization circuit at about 5 V to one or more signals sent to the one or more processing components at about 1.8 V.

8. The system of claim 7, wherein the one or more signals received from the one or more processing components comprise a convert (CONV) signal from the EVSYS.

9. The system of claim 7, wherein the one or more signals received from the one or more processing components comprise digital controls for the one or more digitization circuits.

10. The system of claim 1, wherein the one or more processing components further comprise:
one or more ambient temperature sensors operatively coupled to the ADC.

11. The system of claim 1, wherein the one or more processing components further comprise:
a system clock and a memory operatively coupled to the processor, the memory storing computer-readable instructions that, when executed by the processor, generate a CONV signal based off a timing signal from the system clock.

12. The system of claim 11, wherein the CONV signal extends a natural period of the integration of the one or more digitization circuits from a few milliseconds to as long as desired.

13. The system of claim 11, wherein the system clock and the one or more digitization circuits operate at a clock rate of about 15 MHz.

14. The system of claim 1, wherein the one or more processing components further comprise:
a power supply operatively coupled to the first part of the I/O connector, the power supply configured to step down an input voltage of about 24 VDC to an operating voltage of the one or more processing components.

15. The system of claim 1, wherein the first part of the I/O connector and the second part of the I/O connector are configured to be attached and detached.

16. The system of claim 15, wherein the communications interface is configured for communications through one or more interfaces and/or protocols comprising Ethernet, EtherCAT, CAN, ProfiBus, ProfiNet, and USB.

17. The system of claim 15, wherein the protection circuitry comprises one or more fuses configured in series and a transient-voltage-suppression (TVS) diode.

18. The system of claim 1, wherein one or more of the one or more processing components and the one or more I/O components are disposed on a printed circuit board (PCB) having a thickness of approximately 0.8 mm.

19. The system of claim 1, wherein the one or more digitization circuits convert an analog signal from the photo detector proportional to an intensity of infrared (IR) radiation to a 20-bit digital number.

20. The system of claim 1, wherein the EVSYS is a peripheral that allows other peripherals on the one or more processing components to signal directly to each other independently of the processor.
